(19) United States
(12) Patent Application Publication
(10) Pub. No.: US 2009/0226668 A1
(43) Pub. Date: Sep. 10, 2009

(54) OPTIMIZED SURFACE FOR CELLULAR PROLIFERATION AND DIFFERENTIATION

(75) Inventor: Joshua Simon, Rockaway, NJ (US)

Correspondence Address: HARNESS, DICKEY & PIERCE, P.L.C., P.O. BOX 828, BLOOMFIELD HILLS, MI, 48303, US

(73) Assignee: EBI, L.P., Parsippany, NJ (US)

(21) Appl. No.: 12/045,463

(22) Filed: Mar. 10, 2008

(51) Int. Cl. B32B 3/30; B32B 18/00; B05D 5/00; B32B 5/16

(52) U.S. Cl. 428/143; 428/210; 428/156; 427/287

(57) ABSTRACT

A ceramic scaffold comprising a ceramic substrate having a surface with a first microtexture on at least a portion of the surface and a first erodable coating having a smooth surface, said first coating covering at least a portion of the first microtexture. The microtexture may be formed of peaks, valleys, or a combination of peaks and valleys from about 1 micrometer to about 100 micrometers in each of height, length, and width. The peaks, valleys, or combination of peaks and valleys may be elongated and oriented in the same direction on the surface. The microtexture may also be asymmetrically arranged on the surface of the ceramic substrate.

### INTRODUCTION

The present technology relates to ceramic scaffolds useful for repair of tissue defects.

Tissue defects, such as osseous defects, may be caused by trauma, disease, surgical intervention, or other situations. Some defects require treatment, such as filling the defect with an implant. Implants can be made in variety of shapes and forms and can include a scaffold material that may be either resorbable or non-resorbable. Scaffolds can be formed of materials such as biocompatible metals, ceramics, or composites and can be designed and formed with spaces, pores, or voids in order to facilitate cell ingrowth and proliferation resulting in new tissue growth. Tissues, such as connective tissue and/or bone tissue, can be generated from cells that populate the scaffold and subsequently differentiate into specialized cell types.

### SUMMARY

The present technology provides a ceramic scaffold that includes a ceramic substrate having a surface with a first microtexture on at least a portion of the surface and a first erodable coating having a smooth surface, said first coating covering at least a portion of the first microtexture. The microtexture may be formed of peaks, valleys, or a combination of peaks and valleys from about 1 micrometer to about 100 micrometers in each of height, length, and width. The peaks, valleys, or combination of peaks and valleys may be elongated and oriented in the same direction on the surface. The microtexture may also be asymmetrically arranged on the surface of the ceramic substrate.

The ceramic scaffold may further include a plurality of erodable coatings. For example, the ceramic scaffold may include a second erodable coating having a second microtexture, said second erodable coating covering at least a portion of the first erodable coating. The second erodable coating may have a faster erosion rate than the first erodable coating. The ceramic scaffold may also have a third erodable coating having a smooth surface, said third coating covering at least a portion of the second erodable coating.

The present technology also provides methods for preparing a ceramic scaffold. Methods include the steps of providing a ceramic substrate having a surface; forming a first microtexture on at least a portion of the surface of the ceramic substrate; and covering at least a portion of the microtexture with a first erodable coating having a smooth surface. Methods may include covering at least a portion of the first erodable coating having a smooth surface with a second erodable coating, and forming a second microtexture on at least a portion of the surface of the second erodable coating. The present methods may further include covering at least a portion of the second microtexture with a third erodable coating having a smooth surface.

The present compositions and methods provide ceramic scaffolds that allow for growth and population of the scaffold with cells. After implantation at the site of a tissue defect, cell growth can occur on the smooth surface of the erodable coating. Following erosion of the coating, a microtextured surface can be exposed to promote cell differentiation and bone formation. The exposed microtexture can allow cells to differentiate into specialized tissue. The ceramic scaffolds are beneficial in treating tissue defects with the combination of cell growth and differentiation serving to facilitate integration of the scaffold into surrounding tissues.

### BRIEF DESCRIPTION OF THE DRAWINGS

The present technology will become more fully understood from the detailed description and the accompanying drawings, wherein:

FIG. 1 is a partial cross-sectional view of a first embodiment of a scaffold constructed in accordance with the present teachings;

FIG. 2 is a partial cross-sectional view of a second embodiment of a scaffold constructed in accordance with the present teachings;

FIG. 3 is a partial cross-sectional view of a third embodiment of a scaffold constructed in accordance with the present teachings;

FIG. 4 is a partial cross-sectional view of a fourth embodiment of a scaffold constructed in accordance with the present teachings; and

FIG. 5 is a partial cross-sectional view of a fifth embodiment of a scaffold constructed in accordance with the present teachings.

It should be noted that the figures set forth herein are intended to exemplify the general characteristics of an apparatus, materials and methods among those of this invention, for the purpose of the description of such embodiments herein. These figures may not precisely reflect the characteristics of any given embodiment, and are not necessarily intended to define or limit specific embodiments within the scope of this invention.

### DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure, and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. Any discussion of the content of references cited in the Introduction is intended merely to provide a general summary of assertions made by the authors of the references, and does not constitute an admission as to the accuracy of the content of such references. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology.

“A” and “an” as used herein indicate “at least one” of the item is present; a plurality of such items may be present, when possible.

The present technology provides tissue implants that include one or more scaffold materials that have either a smooth surface or a topographical or textured surface and are formed using materials that facilitate bone regeneration. After implantation, the scaffold may be populated with various cell types, including osteoprogenitor cells, stem cells, osteoblasts, osteoclasts, and immune cells. These various cell types can begin a process of proliferating throughout the scaffold and subsequently form new tissue, with these activities depending on the design and surface qualities of the scaffold.

It has been found that scaffolds used to regenerate or replace tissue, such as bone tissue, can perform better when cell growth into the scaffold is optimized. Cell motility and proliferation can occur best on smooth surfaces, while on the other hand, cell differentiation and expression of tissue factors can occur best on surfaces with some form of topography or texture. Consequently, these two different surface types preclude simultaneous proliferation and differentiation optimums, as each optimum comes at the expense of the other.

Since cell proliferation and differentiation activities depend on the type of surface on which the cells adhere, scaffolds can initially accommodate one or the other phase of cellular life by having either a smooth surface or a textured surface. The scaffolds of the present technology provide multiple surface characteristics in use, as one type of surface yields to another type of surface by erosion of a coating covering all or part of the scaffold. In some embodiments, multiple erodable coatings can be used to cycle through various surface types, for example, by presenting cells with consecutive surfaces that change between smooth and textured in order to optimize proliferation and differentiation events over time. As a result, for example, the implants allow for optimal growth and population with bone-forming cells followed by erosion and changing of the scaffold surface to promote cell differentiation and bone formation.

In some embodiments, a ceramic scaffold includes a ceramic substrate having a surface with a first microtexture on at least a portion of the surface. A first erodable coating having a first smooth surface covers at least a portion of the first microtexture. Part of an exemplary embodiment of such a ceramic scaffold is depicted in FIG. 1. As illustrated, the a surface portion of the ceramic substrate 30 has a first microtexture 40 that is covered in whole or in part with a first erodable coating 20 that forms a smooth outer surface 10.

The ceramic scaffold may be formed of various materials that can be shaped into various geometries, depending on the particular application or shape desired. Scaffold shapes, ceramic substrate materials, including substructures and/or composite materials include those described in U.S. Patent Application Publication No. 2006/0271201, Kumar et al., published Nov. 30, 2006, which is incorporated herein by reference. For example, the ceramic substrate may be formed into a plug, sheet, or may include granules. Granular forms of the ceramic substrate may include granules from about 0.5 mm to about 1 mm in average diameter.

In various embodiments, the ceramic substrate is shaped for easy use and manipulation. The initial ceramic scaffold shape may be split, shaved, cut, or pulverized to create any final shape of a reduced size. For example, if the desired scaffold shape for implantation is a cube, a larger rectangular block could be split to provide the cube or the rectangular block could be fragmented to provide a plurality of free form pieces. Breaking of the larger scaffold may be achieved by hand manipulation or by using a tool such as a hammer or chisel. The initial larger ceramic scaffold may be scored, for example, to include break lines to facilitate creating several pieces from the larger body.

In some embodiments, the ceramic scaffold contains various pores. Cells may move through, proliferate, and differentiate within the pores of the scaffold. The cells may ultimately fill the pores with new tissue and subsequently may enlarge the pores, in the case of resorbable ceramic substrates, ultimately replacing the entire implant in some instances. The pores may further include voids of similar or differing shapes. Pores may partially or completely transverse the scaffold or pores may be distributed localized to a particular region of the scaffold. The scaffold may be of high porosity having from about 70% to about 90% pore volume, or of a lesser porosity, having from about 25% to about 70% pore volume. Pores may be of a uniform size, a collection of different sizes, or randomly sized. The pores may include channels. For example, pores may be open to one another to form a continuous path or channel through the scaffold. In various embodiments, the scaffold is sponge-like, comprising a plurality of different sized pores which may or may not be continuous and/or interconnected.

It is understood that the size of pores may be altered by one skilled in the art based on the ceramic scaffold dimensions, desired end weight, desired porosity, and intended usage. The combination of porosity, pore shape, and materials used may impact the structural integrity of the ceramic scaffold. By selecting the proper materials and porosity, the scaffold may provide load bearing capabilities.

A scaffold material may include osteoconductive materials, osteoinductive materials, and combinations thereof. In various embodiments, scaffold materials include those selected from the group consisting of bone (including cortical and cancellous bone), demineralized bone, ceramics, polymers, and combinations thereof. Suitable polymers may include biological polymers, such as polypeptides or multi-polypeptide structures, such as for example collagen. Other scaffold materials include gelatin, polyglycolic acid, polylactic acid, polypropylenefumarate, polyethylene glycol, and copolymers or combinations thereof.

In some embodiments, the scaffold comprises demineralized bone, collagen or mixtures thereof. The relative amounts of the demineralized bone material, collagen or mixtures thereof may be up to 90% of the final weight of the ceramic scaffold. Demineralized bone matrix is a resorbable scaffold material known to possess high osteoinductive potential. Demineralized bone matrix may include bone from a single member of the same species as the patient to reduce or prevent an immunogenic response or the bone may come from multiple donors. The demineralized bone matrix may be from a cortical, cancellous and/or corticocancellous bone. As used herein, the term “demineralized” and variants thereof, refers to a reduced content of mineral constituents or mineral salts of a bone tissue relative to its natural state. The demineralized bone may have a calcium concentration of about 1%. The demineralized bone may be dried to a final moisture level of about less than 6% as recommended by the American Association of Tissue Banks.

In some embodiments, the scaffold may include collagen materials that may be natural or modified. Natural collagen materials may include nonhydrolyzed native proteins derived from the connective tissue of animals, humans, fish, and any other living being which produces collagen. Modified collagen may be hydrolyzed collagen which is the hydrolysate of animal or fish collagen derived by acid, enzyme, or another suitable means of hydrolysis. Collagen may include lyophilized or skin-derived collagen as disclosed in U.S. Patent Application Publication No. 2007/0092494, Higgins et al., published Apr. 26, 2007.

Ceramic substrates may include any of a variety of ceramic materials known in the art for use for implanting in bone or any biocompatible ceramic. In various embodiments, ceramic substrates used in the scaffold may include calcium salts, calcium carbonate, calcium phosphate, tricalcium phosphate, tetracalcium phosphate, hydroxyapatite, and combinations thereof. Ceramics useful herein also may include those described in U.S. Pat. No. 6,323,146, Pugh et al., issued Nov. 27, 2001, and U.S. Pat. No. 6,585,992, Pugh et al., issued Jul. 1, 2003, which are incorporated herein by reference. A suitable commercially available ceramic is Pro Osteon™ from Interpore Cross International, Inc. (Irvine, Calif., USA).

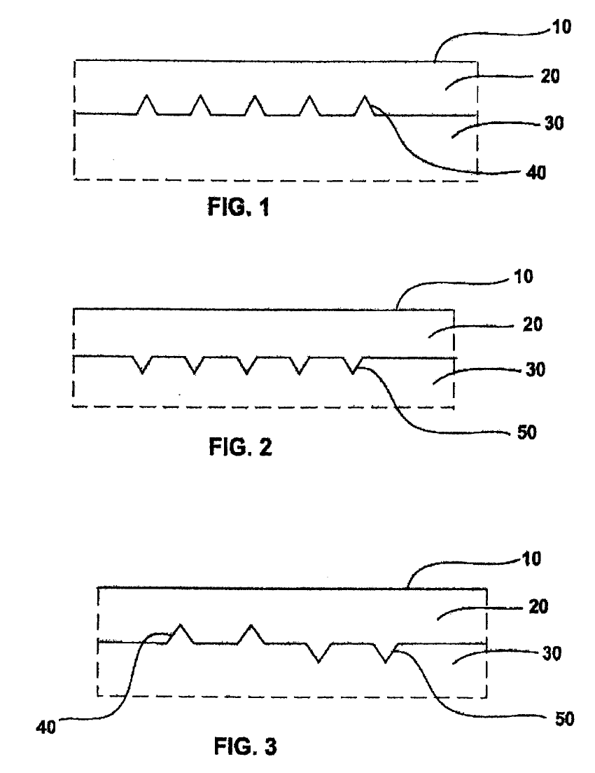

In various embodiments, the ceramic scaffold includes topography or texture on the surface of the ceramic substrate. Topography or texture may be in the form of microtexture. Microtexture may be formed of peaks, valleys, or both peaks and valleys, where these features may range from about 1 micrometer to about 100 micrometers in each of height, length, and width. In the case of valleys, the height is the depth of the feature. An exemplary embodiment of microtexture including peaks 40 is shown in cross-section in FIG. 1 and an exemplary embodiment of microtexture including valleys 50 is shown in cross-section in FIG. 2. Microtexture may include features having regular spacing (as shown in FIGS. 1 and 2) or irregular spacing (not shown), and may include combinations of these features in varying proportions (not shown). In addition, microtexture formed of peaks or valleys may include various geometric shapes and profiles, including but not limited to, square, rectangular, polygonal, hemispherical, irregular profiles, as well as the triangular profiles shown in FIGS. 1 and 2.

As shown in FIGS. 1 and 2, the microtexture 40, 50 is on the surface of the ceramic substrate 30. In some embodiments, the microtexture 40, 50 covers the entire surface of the ceramic substrate 30. The erodable coating 20 may cover from part to all of the microtexture 40, 50 providing an outer smooth surface 10.

In some cases, the microtexture is formed of elongated peaks, valleys, or both that are oriented in the same direction on the surface. For example, elongated peaks may include ribs running along the surface of the ceramic substrate and elongated valleys may include channels cut into the surface of the ceramic substrate. The elongated peaks and valleys may have a length that runs across a major surface of the ceramic substrate; for example, where the scaffold has a cylindrical or plug shape, the elongated peaks and valleys may run axially from one end to the other end. The elongated peaks and valleys may also be aligned in a particular direction, just a portion may be aligned, or the peaks and valleys may be randomly oriented. Various embodiments include intersecting elongated peaks and valleys. In some embodiments, the microtexture is formed of elongated peaks, valleys, or both where each feature has width and height from about 1 micrometer to about 100 micrometers, while the length may be greater than 100 micrometers. In various embodiments, the elongated peaks, valleys, or both may each have length that is at least twice the width.

In various embodiments, the microtexture may be asymmetrically arranged on the surface of the ceramic substrate. For example, the ceramic substrate may have microtexture on just one end or face. In some embodiments, asymmetric microtexture includes peaks, valleys, or both that are elongated in a particular direction.

The ceramic scaffold of claim may further include a ceramic substrate having more than one form of microtexture. For example, a ceramic substrate having a first microtexture portion may also have a portion having a second, different microtexture. An exemplary embodiment is shown in FIG. 3, where the ceramic substrate 30 surface has a microtexture portion including peaks 40 and a second microtexture portion including valleys 50. The embodiment in FIG. 3 depicts the erodable coating 20 covering both types of microtexture 40, 50, but in some embodiments the erodable coating covers only a portion of each microtexture or a portion of just one type of microtexture (not shown).

In some embodiments, the different microtexture includes the same type of feature but has a different feature density or frequency. The change in features from the microtexture to the different microtexture may be gradual or may be abrupt. For example, where the change is gradual, a gradient may exist between the microtexture and the different microtexture. The gradient may involve one or more changes in density, frequency, dimension of the features, including height, length, and width, or changes in the proportions of features in microtextures formed of two or more types of features.

Microstructure may be created by any suitable method, including those known in the art. For example, microstructure may be the product of laser surface treatment, chemical etching, particulate abrasion, or formed by sintered particles. Methods of forming microstructure and methods of characterizing microstructure are described elsewhere herein.

The ceramic scaffold includes an erodable coating covering at least a portion of the microtexture to form a smooth outer surface over the microtexture. The erodable coating may be eroded over time, where the surface of the scaffold may change from smooth when the coating is present to microtextured once the coating is eroded to expose the microtextured portion of the ceramic substrate. The erodable coating may be eroded by cells via enzymatic degradation or the erodable coating may dissolve, break down, or slough off of the ceramic substrate over time. In various embodiments, the erodable coating includes, but is not limited to, one or more of: calcium sulfate, bioactive glass, biodegradable polymer, polylactic acid, polyglycolic acid, hyaluronic acid, tyrosine-derived polycarbonates, and tyrosine-derived polyarylates. Embodiments of the erodable coating may also include demineralized bone matrix, collagen, naturally occurring tissue-derived proteins, such as elastin, silk, fibrin, fibrinogen, etc., natural polysaccharides, including chitin, chitosan, alginate, carboxymethylcellulose, other polysaccharides, and various mixtures thereof.

In some embodiments, the thickness of the erodable coating is adjusted to achieve a desired erosion rate. In various embodiments, a majority of the erodable coating is eroded in about 3 days to about 14 days post-implantation of the scaffold. The thickness and the erosion rate of the erodable coating may be adjusted in order to optimize the time at which a majority of the erodable coating is eroded or when the entire erodable coating is eroded. Such adjustment of the thickness of the erodable coating coupled with its erosion rate allows predictable exposure of underlying microtexture present on the ceramic substrate or another erodable coating layer. Consequently, the scaffold may be optimized for a smooth surface that promotes cell motility and proliferation followed by exposure of microtexture due to erosion at a predefined time point in order to stimulate cell differentiation.

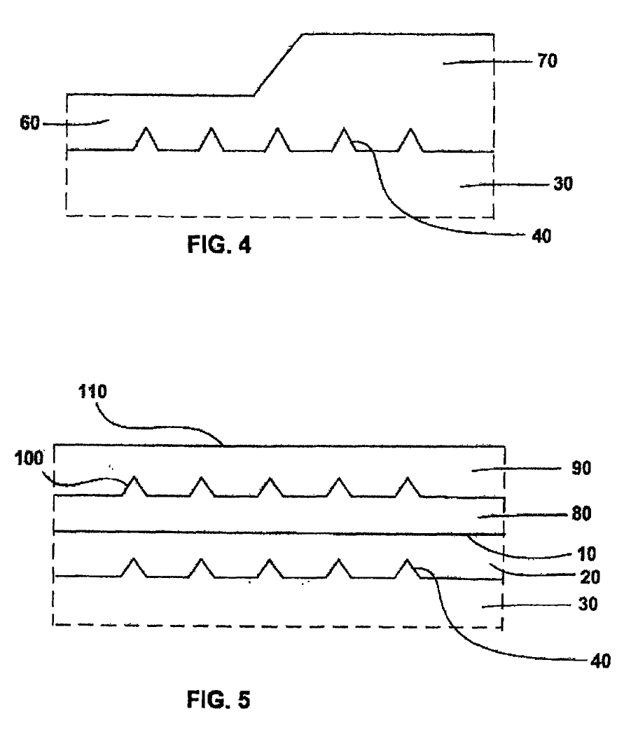

In some cases, the ceramic scaffold has a varying thickness. An exemplary embodiment of an erodable coating having varying thickness is shown in FIG. 4, where the microtextured 40 ceramic substrate 30 is covered with a thin layer 60 of erodable coating compared to another portion covered with a thick layer 70 of erodable coating. The varying thickness of the erodable coating may result in different rates of erosion and exposure of portions of the microtexture on the ceramic substrate or an underlying erodable coating. For example, a portion of the ceramic scaffold may have a thicker erodable coating having a smooth surface to maintain cell migration and proliferation longer than a portion having a thinner erodable coating, where the thinner coating erodes quicker to expose the microtexture and promote cell differentiation in that region. In some cases, the erodable coating thickness may be asymmetric so that the scaffold presents microtexture to the cells over time in a directional manner.

In various embodiments, the smooth surface of the erodable coating contains texture or topography that is less pronounced than the texture of the ceramic substrate. In some embodiments, the smooth surface of the erodable coating contains surface features that are smaller relative to the surface features of the ceramic substrate. For example, the smooth surface of the erodable coating may be formed of peaks, valleys, or both that have dimensions of height, length, and width each less than the microtexture on the surface of the ceramic substrate. Thus, the smooth surface of the erodable coating may contain smaller features than microtexture on a ceramic substrate or on an underlying erodable coating. In some cases, the smooth surface of the erodable coating is formed of peaks, valleys, or a combination of peaks and valleys less than 1 micrometer in each of height, length, and width.

Various embodiments of a ceramic scaffold include a plurality of erodable coatings. In some embodiments, a ceramic scaffold includes a second erodable coating having a second microtexture covering at least a portion of a first erodable coating. An embodiment is shown in FIG. 5, where a ceramic substrate 30 having a first microtexture 40 is covered with a first erodable coating 20 having a smooth surface 10. The smooth surface 10 of the first erodable coating 20 is covered with a second erodable coating 80 having a second microtexture 100. The second erodable coating may have a faster erosion rate than the first erodable coating. In some cases, a majority of the second erodable coating is eroded prior to erosion of the first erodable coating.

In some embodiments, the ceramic scaffold includes a third erodable coating having a smooth surface covering at least a portion of the second erodable coating. Referring again to FIG. 5, the third erodable coating 90 with a smooth surface 110 is shown covering the second microtexture 100 of the second erodable coating 80. The third erodable coating may have a faster erosion rate than the second erodable coating.

Various embodiments of the ceramic scaffold include more than three erodable coatings (not shown). These multiple erodable coatings may alternate between microtextured and smooth or may include consecutive erodable coatings that have the same or different microtexture or where the consecutive erodable coatings are smooth.

In some embodiments, the erodable coating includes a biologically active agent. The biologically active agent may be one or more of: an antibiotic, growth factor, cytokine, hormone, nutrient, anti-inflammatory agent, calcium containing material, bone morphogenic protein, and blood product. Suitable biologically active agents are also disclosed in U.S. Pat. No. 6,180,606, Chen et al., issued Jan. 30, 2001, incorporated herein by reference. Depending on the bioactive material selected, the erodable coating itself may be osteogenic and osteoinductive.

Nutrient factors useful herein include a compound or mixture of compounds used to sustain metabolic activities or used to promote normal physiologic function or optimal health. Nutrient factors include, but are not limited to, vitamins, hormones, individual or combinations of amino acids, carbohydrates or derivatives thereof, fats or derivatives thereof, alcohols or derivatives thereof, inorganic salts, and trace elements.

Bone morphogenic proteins useful herein include any of the zinc metalloendopeptidase enzymes involved in induction of bone and cartilage formation. Bone morphogenic proteins include Bone Morphogenic Protein-2 (BMP-2), Bone Morphogenic Protein-2a (BMP-2a), Bone Morphogenic Protein-4 (BMP-4), Bone Morphogenic Protein-5 (BMP-5), Bone Morphogenic Protein-6 (BMP-6), Bone Morphogenic Protein-7 (BMP-7), and Bone Morphogenic Protein-8 (BMP-8). In various embodiments, the bone morphogenic proteins are heterodimers. Such heterodimers comprise two different BMPs, such as BMP-2 and BMP-7.

Growth factors useful herein include any substance that is operable to stimulate cell growth. Exemplary growth factors include Transforming Growth Factor-beta (TGF-beta), Transforming Growth Factor-alpha (TGF-alpha), Epidermal Growth Factor (EGF), Insulin-like Growth Factor-I or II, Interleukin-I, Interferon, Tumor Necrosis Factor, Fibroblast Growth Factor (FGF), Platelet Derived Growth Factor (PDGF), and Nerve Growth Factor (NGF).

Anti-inflammatories useful herein include steroidal agents such as flucinolone and hydrocortisone, and nonsteroidal agents (NSAIDs), including COX-1 inhibitors, COX-2 inhibitors, and mixed COX-1/COX-2 inhibitors. NSAIDs among those useful herein include ketorolac, flurbiprofen, ibuprofen, naproxen, indomethacin, diclofenac, etodolac, indomethacin, sulindac, tolmetin, ketoprofen, fenoprofen, piroxicam, nabumetone, aspirin, diflunisal, meclofenamate, mefenamic acid, oxyphenbutazone, phenylbutazone, celecoxib, rofecoxib, and mixtures thereof.

Blood products useful herein include a product or any component which is derived from blood. Blood products include whole blood and blood fractions, such as plasma (such as platelet-poor plasma and platelet-rich plasma), blood cells, blood factors, blood related proteins, unspecialized cells such as stem cells (including adipose derived stem cells), and specialized cells, e.g., types of leukocytes such as lymphocytes and dendritic cells.

Other suitable bioactive materials include inorganic materials, osteoblasts, amino acids, gelatin, additional collagen, naturally occurring or synthetic therapeutic drugs, proteins, enzymes, and mixtures thereof.

The present technology also provides methods for preparing a ceramic scaffold. Various embodiments include providing a ceramic substrate having a surface and forming a microtexture on at least a portion of the surface of the ceramic substrate. At least a portion of the microtexture is then covered with an erodable coating having a smooth surface.

In some embodiments, the step of forming the microtexture on at least a portion of the surface of the ceramic substrate includes treating the surface of the ceramic substrate with laser pulses. For example, laser surface treatment may include using a KrF excimer laser with 248 nm radiation wavelength to apply a 30 ns pulse to ablate and/or melt material on the ceramic substrate or erodable coating to form microtexture. Laser surface treatment may be performed using a mask projection micromachining system. The mask can define the laser spots projected onto the material surface, while a beam homogenizer can be used to obtain a uniform fluence at the material surface. Laser processing parameters may include: laser fluence of 1 J/cm², pulse frequency of 10 Hz, and 1000 laser pulses per spot.

The step of forming the microtexture on at least a portion of the surface of the ceramic substrate may include etching the surface of the ceramic substrate with an acid, base, or solvent. The duration of the treatment and strength or concentration of the acid, base, or solvent etching can be varied depending on the surface texture desired, extent of etching achieved, and susceptibility of the surface to the etching. In some cases, the surface material of the ceramic substrate or the erodable coating includes a composite of two or more materials where at least one of the materials is susceptible to chemical etching using the acid, base, or solvent. Etching of the composite can remove the susceptible material producing valleys, with the more resistant remaining material forming peaks. In some cases, the composite is formed by sintering at least two types of particles to form either the ceramic substrate or erodable coating that is then chemically etched.

In some embodiments, the step of forming the microtexture on at least a portion of the surface of the ceramic substrate includes abrading the surface of the ceramic substrate with an abrasive particle. For example, the surface of the ceramic substrate or erodable coating may be textured by tumbling with media containing abrasive particles. In various embodiments, abrasive particles can be forced across the surface at high speeds akin to sandblasting or bead blasting in order to form microtexture.

In various embodiments, the step of forming the microtexture on at least a portion of the surface of the ceramic substrate includes sintering the ceramic substrate to form a surface with microtexture. Particles of ceramic substrate or erodable coating having micron sized proportions (e.g., from about 1 micron to about 100 microns in average diameter) may be sintered, adhering the micron-sized particles together and leaving some voids or gaps between the former particles. In some cases, larger sized particles of greater than 100 microns, including particles ranging from about 0.5 mm to about 1 mm, may be sintered. Depending on the shape and packing of the particles, different sized voids or gaps exist in the sintered product. These voids or gaps may result in microtexture on the surface of the ceramic substrate or erodable coating. In an exemplary embodiment, hydroxyapatite powder is sieved to select a particular particle size. A ceramic cylindrical disc can be obtained by uniaxial compression at 157 MPa. The sintering cycle may include: sintering for 1 h at 1200° C. in a furnace; using a heating rate of 48° C./min.; and completing the sintering cycle by cooling inside the furnace.

Microtexture can also be formed on the surface of the ceramic substrate during formation of the substrate, without subsequent machining or surface modifying steps. Such methods include those of “robocasting,” whereby suspensions of highly concentrated ceramic materials are deposited in layer-by-layer fashion to produce three-dimensional substrates of high complexity. Such processes are described in U.S. Pat. No. 6,993,406, Cesarano III, et al., issued Jan. 31, 2006. Substrates can also be made with surface microtexture by “direct ink writing,” whereby layer-by-layer structures are built through deposition of colloidal- or polymer-based inks. Such processes are described in Lewis et al., “Direct Ink Writing of Three-Dimensional Ceramic Structures,” 89 J. American Ceramic Society 3599-3609 (December 2006).

In some cases, microtexture is formed on the surface of the ceramic substrate or erodable coating using a combination of the aforementioned methods. For example, a microtexture can be formed on one portion of the ceramic substrate or erodable coating using laser pulses and a different microtexture can be formed on another portion of the ceramic substrate or erodable coating using chemical etching. Also, a combination of the aforementioned methods may be applied to the same portion of the ceramic substrate or erodable coating to form microtexture.

The physical properties of microtextures resulting from the aforementioned methods may be ascertained using various techniques, as known in the art, including: contact angle measurement, atomic force microscopy (AFM), scanning electron microscopy (SEM), and confocal laser scanning microscopy (CLSM). These techniques allow characterization of the compositions and methods disclosed herein.

Various methods may be used to apply one or more erodable coatings to the ceramic scaffold. The erodable coating may cover microtexture on the ceramic substrate or may cover a previously applied erodable coating having a surface that is smooth or that has microtexture. The erodable coating may be applied using general coating methods and techniques as known in the art. For example, in some embodiments, the erodable coating is applied by dipping the ceramic scaffold into a liquid coating composition. The coating may then be dried, cured, or crosslinked as necessary to form a film. In some cases, the erodable coating is applied by spraying. The sprayed coating may be dried, cured, or crosslinked as necessary to form a film. In various embodiments, the erodable coating is applied as a film and laminated to the ceramic substrate or a previously applied erodable coating. Laminating may include thermal and/or chemical treatment, including use of an adhesive, to bond the film. Some embodiments include applying the erodable coating by sintering particles of the erodable coating to form a layer over the ceramic substrate or a previously applied erodable coating.

The ceramic scaffold may be sterilized using methods known in the art, including irradiation and/or chemical treatment.

Embodiments of the present ceramic scaffolds may be used to repair tissue defects including bone defects. Tissue defects, bone defects, and injury sites can include imperfections caused by birth defect, trauma, disease, decay or surgical intervention, and the desired repair may be for therapeutic or cosmetic reasons. Additional scaffold applications, defects, augmentation of defect sites, and repairs that may incorporate the present ceramic scaffolds are further disclosed in U.S. Patent Application Publication No. 2006/0271201, Kumar et al., published Nov. 30, 2006, which is incorporated herein by reference. The present scaffolds may also be employed in surgical and dental procedures, and are suitable for use with the various treatments and methods disclosed in U.S. Pat. No. 6,180,606, Chen et al., issued Jan. 30, 2001, and U.S. Pat. No. 5,507,813, Dowd et al., issued Apr. 16, 1996, both of which are incorporated herein by reference.

The figures and other embodiments described herein are exemplary and not intended to be limiting in describing the full scope of compositions and methods of this technology. Equivalent changes, modifications and variations of specific embodiments, materials, compositions and methods may be made within the scope of the present technology, with substantially similar results.

What is claimed is:

1. A ceramic scaffold comprising:
a ceramic substrate having a surface with a first microtexture on at least a portion of the surface; and
a first erodable coating having a first smooth surface, said first coating covering at least a portion of the first microtexture.

2. The ceramic scaffold of claim 1, wherein the ceramic substrate is selected from a group consisting of calcium salt, calcium carbonate, calcium phosphate, tricalcium phosphate, tetracalcium phosphate, hydroxyapatite, and combinations thereof.

3. The ceramic scaffold of claim 1, wherein the ceramic substrate is in the form of a plug, a sheet, or granules having a size of from about 0.5 mm to about 1 mm.

4. The ceramic scaffold of claim 1, wherein the first microtexture is formed of peaks, valleys, or a combination of peaks and valleys having dimensions of from about 1 micrometer to about 100 micrometers in each of height, length, and width.

5. The ceramic scaffold of claim 1, wherein the first microtexture is formed of peaks, valleys, or a combination of peaks and valleys that are elongated and oriented in the same direction on the surface.

6. The ceramic scaffold of claim 1, wherein the first microtexture is formed by laser surface treatment, chemical etching, particulate abrasion, or by sintering of particles.

7. The ceramic scaffold of claim 1, wherein the first microtexture is asymmetrically arranged on the surface of the ceramic substrate.

8. The ceramic scaffold of claim 1, wherein the first microtexture covers the entire surface of the ceramic substrate.

9. The ceramic scaffold of claim 1, further comprising a different microtexture on a different portion of the surface of the ceramic substrate than the portion having the first microtexture.

10. The ceramic scaffold of claim 1, wherein the first erodable coating is selected from the group consisting of calcium sulfate, bioactive glass, biodegradable polymer, polylactic acid, polyglycolic acid, hyaluronic acid, tyrosine-derived polycarbonates, tyrosine-derived polyarylates, and combinations thereof.

11. The ceramic scaffold of claim 1, wherein the first erodable coating has a varying thickness covering at least a portion of the first microtexture.

12. The ceramic scaffold of claim 1, wherein a majority of the first erodable coating can erode from about 3 days to about 14 days post implantation.

13. The ceramic scaffold of claim 4, wherein the first smooth surface of the first erodable coating is formed of peaks, valleys, or a combination of peaks and valleys that have dimensions of height, length, and width each less than the first microtexture.

14. The ceramic scaffold of claim 1, wherein the first smooth surface of the first erodable coating is formed of peaks, valleys, or a combination of peaks and valleys having dimensions less than 1 micrometer in each of height, length, and width.

15. The ceramic scaffold of claim 1, wherein the first erodable coating further comprises a biologically active agent.

16. The ceramic scaffold of claim 15, wherein the biologically active agent is selected from the group consisting of antibiotics, growth factors, cytokines, hormones, nutrients, anti-inflammatory agents, and combinations thereof.

17. The ceramic scaffold of claim 1, further comprising a second erodable coating having a second microtexture, said second coating covering at least a portion of the first erodable coating.

18. The ceramic scaffold of claim 17, wherein the second erodable coating has a faster erosion rate than the first erodable coating.

19. The ceramic scaffold of claim 17, further comprising a third erodable coating having a second smooth surface, said third coating covering at least a portion of the second erodable coating.

20. The ceramic scaffold of claim 19, wherein the third erodable coating has a faster erosion rate than the second erodable coating.

21. A method for preparing a ceramic scaffold comprising:
forming a first microtexture on at least a portion of the surface of a ceramic substrate; and
covering at least a portion of the microtexture with a first erodable coating having a smooth surface.

22. The method for preparing a ceramic scaffold of claim 21, wherein forming a first microtexture on at least a portion of the surface of the ceramic substrate comprises at least one of:
treating the surface of the ceramic substrate with laser pulses to form the first microtexture,
etching the surface of the ceramic substrate with an acid, base, or solvent to form the first microtexture;
abrading the surface of the ceramic substrate with an abrasive particle to form a first microtextures; and
sintering the ceramic substrate to form a composite having a surface with the first microtexture.

23. The method for preparing a ceramic scaffold of claim 21, wherein covering at least a portion of the microtexture with a first erodable coating having a smooth surface comprises at least one of:
dipping the ceramic substrate into a coating composition to cover at least a portion of the microtexture with the first erodable coating;
spraying the ceramic substrate with a coating composition to cover at least a portion of the microtexture with the first erodable coating;
laminating the ceramic substrate with a film to cover at least a portion of the microtexture with the first erodable coating; and
sintering particles of an erodable coating to cover at least a portion of the microtexture with the first erodable coating.

24. The method for preparing a ceramic scaffold of claim 21, further comprising forming a different microtexture on at least a portion of the surface of the ceramic substrate.

25. The method for preparing a ceramic scaffold of claim 21, further comprising:
covering at least a portion of the first erodable coating having a smooth surface with a second erodable coating; and
forming a second microtexture on at least a portion of the surface of the second erodable coating.

26. The method for preparing a ceramic scaffold of claim 25, further comprising covering at least a portion of the second microtexture with a third erodable coating having a smooth surface.
